(19) United States
(12) Patent Application Publication
(10) Pub. No.: US 2007/0112103 A1
(43) Pub. Date: May 17, 2007

(54) Molecular system and method for reversibly switching the same

(76) Inventors: Zhang-Lin Zhou, Palo Alto, CA (US); Sivapackia Ganapathiappan, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/262,656

(22) Filed: Oct. 31, 2005

(51) Int. Cl. C08K 5/34; C08K 5/48

(52) U.S. Cl. 524/90

(57) ABSTRACT

A method for reversibly switching a molecular system between three or four states is disclosed. The method includes exposing a photochromic compound within the molecular system to at least one radiation and at least one of an acid and a base. Upon such exposure, the photochromic compound switches from one of the three or four states to an other of the three or four states.

### BACKGROUND

The present disclosure relates generally to molecular systems, and more particularly to methods of reversibly switching molecular systems.

Molecular electronics is a relatively new field that includes the use of individual molecules to perform a variety of functions (e.g., switching) at the nanoscale level. The use of molecules to perform such functions enables the fabrication of devices having nanometer-scale dimensions, thus extending technology to sizes not easily achievable with present semiconductor technology.

Using the interplay of chemical, electrical, and/or optical signals, the molecules may be designed to execute three basic logic operations (AND, NOT, OR) and simple combinations thereof. Under the influence of an appropriate input stimulation, chemical systems may switch from one form to another, thus producing a change in detectable output. The application of simple logic conventions allows the encoding of binary digits in the inputs and outputs, thereby offering the opportunity to reproduce the functions of digital circuits with molecules. However, most of these chemical logic gates are operated in solution.

As such, it would be desirable to provide a process for reproducing the functions of digital circuits and their operating principles with solid materials.

### SUMMARY

A molecular system is disclosed. The molecular system includes a polymer matrix and a photochromic compound associated with the polymer matrix. The photochromic compound is capable of reversibly switching between three or four states upon exposure to at least one radiation and at least one of an acid and a base.

A method for reversibly switching the molecular system between three or four states is also disclosed. The method includes exposing a photochromic compound within the molecular system to at least one radiation and at least one of an acid and a base. Upon such exposure, the photochromic compound switches from one of the three or four states to an other of the three or four states.

### BRIEF DESCRIPTION OF THE DRAWINGS

Objects, features and advantages will become apparent by reference to the following detailed description and drawings, in which like reference numerals correspond to similar, though not necessarily identical components. For the sake of brevity, reference numerals having a previously described function may not necessarily be described in connection with subsequent drawings in which they appear.

FIG. 1 is a schematic diagram depicting an embodiment of a method of reversibly switching a generic molecular system between three states;

FIG. 2 is a schematic diagram depicting an example of a spiropyran molecular system reversibly switching between three states;

FIG. 3 is a schematic diagram depicting an example of a spirooxazine derivative molecular system reversibly switching between three states;

FIG. 4 is a schematic diagram depicting an example of an oxazine derivative molecular system reversibly switching between three states;

FIG. 5 is a schematic diagram depicting an embodiment of a method of reversibly switching a generic molecular system between four states;

FIG. 6 is a schematic diagram depicting an example of a cyclopentene derivative molecular system reversibly switching between four states;

FIG. 7 is a schematic diagram depicting an example of a fulgide derivative molecular system reversibly switching between four states;

FIG. 8 is a flow diagram of the synthesis of spiropyran as a three state molecular memory switch;

FIG. 9 is a flow diagram depicting an embodiment of a method of connecting a photochromic molecule to a monomer that undergoes polymerization to form an embodiment of a molecular system;

FIG. 10 is a schematic diagram depicting the molecular system formed in FIG. 9 reversibly switching between three states;

FIG. 11 is a flow diagram depicting an alternate embodiment of a method of connecting a photochromic molecule to a monomer that undergoes polymerization to form an alternate embodiment of a molecular system;

FIG. 12 is a schematic diagram depicting the molecular system formed in FIG. 11 reversibly switching between three states;

FIG. 13 is a flow diagram depicting another alternate embodiment of a method of connecting a photochromic molecule to a monomer that undergoes polymerization to form another alternate embodiment of a molecular system;

FIG. 14 is a schematic diagram depicting the molecular system formed in FIG. 13 reversibly switching between three states;

FIG. 15A is a schematic representation of two crossed wires, with at least one molecule at the intersection of the two wires; and

FIG. 15B is a perspective elevational schematic view, depicting the crossed-wire device shown in FIG. 1A.

### DETAILED DESCRIPTION

Embodiments of the present disclosure advantageously provide a new type of molecular system that may be converted into a three-stage or four-stage molecular memory switch in a solid state. Embodiments of the molecular system are a three-stage molecular memory switch in a polymer matrix and a four-stage molecular memory switch in a polymer matrix. By taking inputs of at least one radiation, for example, infrared (IR) radiation, ultraviolet (UV) radiation and/or visible radiation, as well as proton stimulations, the switching mechanisms advantageously inter-convert between three or four states which produces substantially significant absorbance changes at two distinct wavelengths in the visible region. Without being bound to any theory, it is believed that in following these operating principles, a logic function may be produced that is associated with a combinational logic circuit with three inputs (i.e. radiation exposure, acid exposure, and base exposure) and two outputs, or four inputs and three outputs.

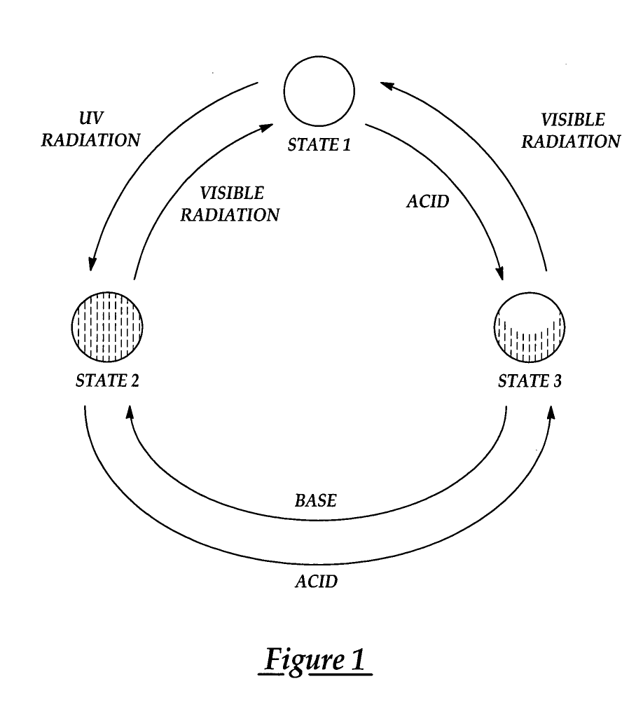

Referring now to FIG. 1, a generic embodiment of the method for reversibly switching a molecular system between three states is depicted. The method includes exposing a photochromic compound within the molecular system to at least one radiation, and at least one of an acid and a base. Upon such exposure, the photochromic compound switches from one of the three states to an other of the three states.

In the general embodiment shown in FIG. 1, the molecular system is substantially colorless in STATE 1, exhibits a hue in STATE 2, and exhibits a hue different from that exhibited in STATE 2 in STATE 3. It is to be understood that the hue exhibited in STATE 3 may be a hue intermediate of STATES 1 and 2. As depicted in FIG. 1, STATE 2 exhibits a purple hue, however, it is to be understood that the hue may vary depending, at least in part, on the photochromic compound used.

The molecular system includes a polymer matrix and a photochromic compound associated with the polymer matrix. In an embodiment, the photochromic compound is associated with the polymer matrix by mixing the photochromic compound throughout the polymer matrix. In another embodiment, the photochromic compound is associated with the polymer matrix by covalently linking the photochromic compound to the polymer matrix. Any suitable polymer matrix may be used that is capable of attaching the photochromic compound. In an embodiment, the polymer matrix is a relatively soft polymer system. A soft polymer system generally refers to a system where the glass transition temperature (T_{g}) of the polymer is relatively low. Non-limitative examples of a relatively low T_{g} include those below about 60° C., or alternately those ranging from about −100° C. to about

Examples of the polymer matrix include, but are not limited to, polymers with an organic backbone (non-limitative examples of which include acrylic or styrene systems), polymers with an inorganic backbone (non-limitative examples of which include polysiloxanes), condensation polymers (non-limitative examples of which include polyesters and polyimides), addition polymers (non-limitative examples of which include polyurethanes and polyureas), and mixtures thereof. It is to be understood that the condensation. and/or addition polymers may be aliphatic, aromatic, or a mixture of aliphatic and aromatic.

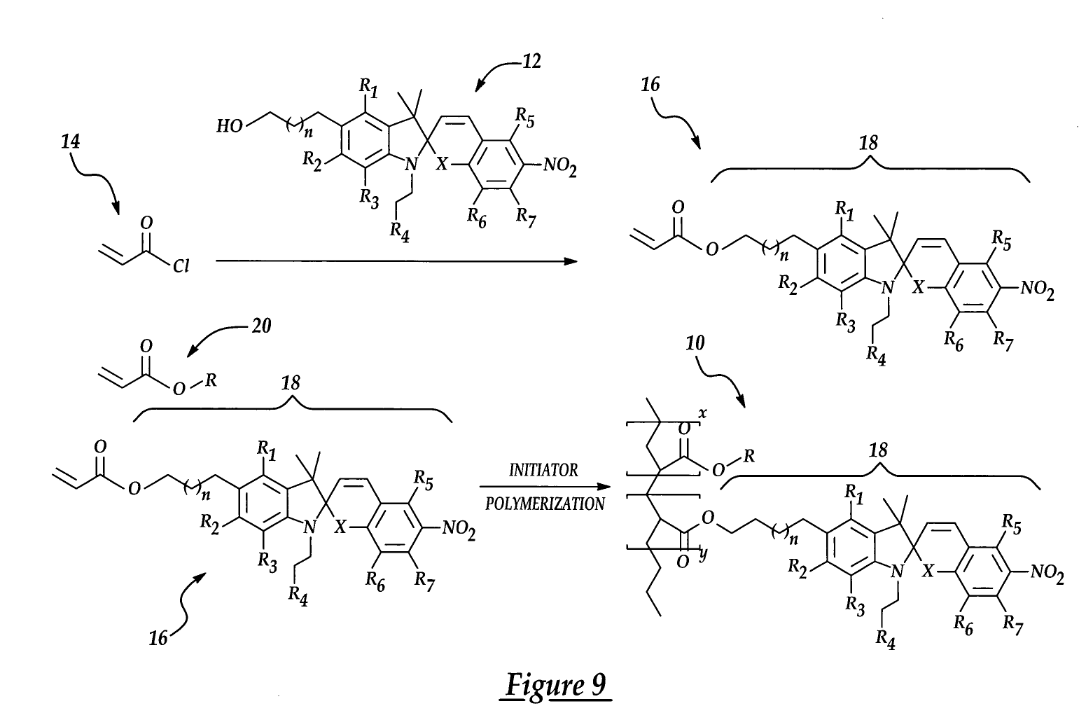

Other specific non-limitative examples of the polymer matrix include polydimethylsiloxane, poly(hexyl acrylate), poly(butyl methacrylate), poly(ethylhexyl methacrylate), poly(benzyl methacrylate), copolymers thereof (non-limitative examples of which include poly(styrene-co-hexyl acrylate), poly(benzyl methacrylate-co-hexyl methacrylate) and poly(methyl methacrylate-co-hexyl acrylate), and mixtures thereof. It is to be understood that these polymers may be mixed with the photochromic compound(s) or may have the photochromic compound(s) chemically linked thereto via suitable linkages. In an embodiment, the linkage may occur with any one of the substituents (e.g. R₁ to R₈ in FIGS. 9, 11, and 13) either by grafting or by linking these compounds to the polymerizable monomers and then polymerizing the monomers using free-radical initiators.

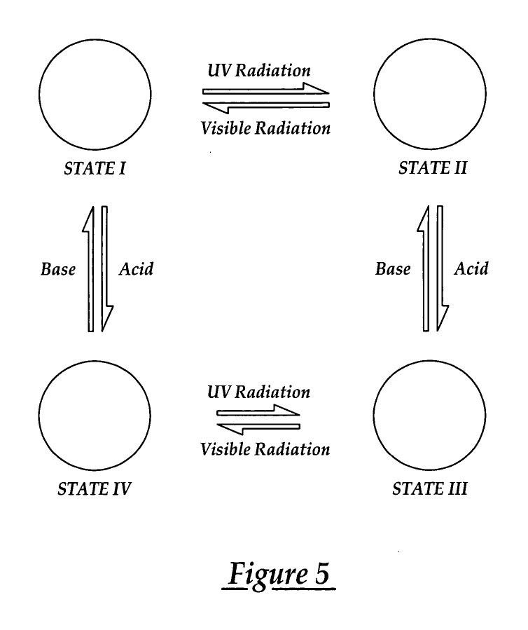

Examples of the photochromic compound that may be attached to or mixed with the polymer matrix include, but are not limited to spiropyran, spiropyran derivatives, spirooxazine derivatives, oxazine derivatives, cyclopentene derivatives, fulgide derivatives, and mixtures thereof. More specifically, the photochromic compounds that are capable of reversibly switching between three states (see FIGS. 1-4) include spiropyran, spiropyran derivatives, spirooxazine derivatives, oxazine derivatives, and mixtures thereof. The photochromic compounds that are capable of reversibly switching between four states (see FIGS. 5-7) include cyclopentene derivatives, fulgide derivatives, and mixtures thereof.

In an embodiment of the method, the molecular system is exposed to radiation, an acid, or a base in order to initiate the switching between the states. Non-limitative examples of the radiation include ultraviolet radiation, visible radiation, or infrared radiation. Non-limitative examples of the acids include at least one of hydrochloric acid, hydrobromic acid, nitric acid, sulfuric acid, acetic acid, phosphoric acid, formic acid, propionic acid and other higher homologues, benzoic acid, phenols, phenol derivatives, and mixtures thereof; while non-limitative examples of the bases include at least one of sodium hydroxide, potassium hydroxide, calcium hydroxide, sodium carbonate, potassium carbonate, cesium carbonate, cesium hydroxide, lithium hydroxide, lithium carbonate, and mixtures thereof.

It is to be understood that by taking inputs of radiation or proton stimulations, the molecular system inter-converts between the three, or four states, thereby producing substantially significant absorbance changes at two distinct wavelengths in the visible spectrum. A logic function associated with a combinational logic circuit with three inputs and two outputs, or four inputs and three outputs, may be produced.

Further, the molecular system may be turned into a three- or four-stage molecular memory switch in a solid state, thereby substantially eliminating the operation of the switching mechanism in solution.

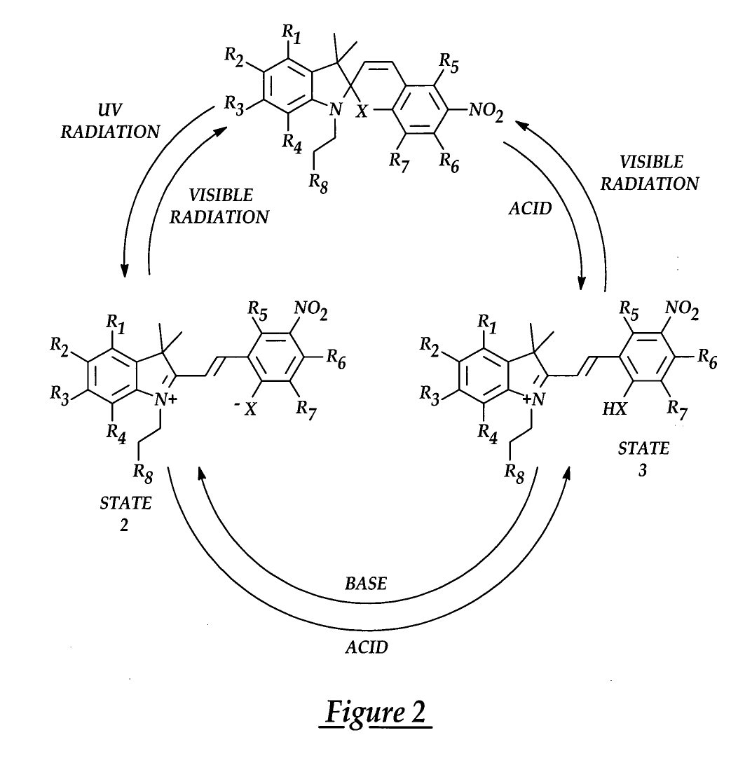

Referring now to FIG. 2, a specific example of the method of reversibly switching between the three states is depicted. The molecular system includes spiropyran as the photochromic compound (shown in STATE 1) attached to a polymer matrix.

In an embodiment, spiropyran in STATE 1 switches to merocyanine in STATE 2 upon exposure to ultraviolet radiation. Merocyanine may be switched to merocyanine H in STATE 3 upon exposure to an acid. The merocyanine H may then be switched to spiropyran in STATE 1 upon exposure to visible radiation.

It is to be understood that the molecular system is reversibly switchable between each of the states. In an embodiment, spiropyran in STATE 1 switches to merocyanine H in STATE 3 upon exposure to an acid. Merocyanine H may then be switched to merocyanine in STATE 2 upon exposure to a base. The merocyanine may then be switched to spiropyran upon exposure to visible radiation.

The spiropyran molecular system depicted in FIG. 2 has one or more R group(s) (e.g. R₁, R₂, R₃, R₄, R₅, R₆, R₇ and R₈) in each of the three states. In a non-limitative example, the “R” group may be a hydrogen atom or an organic group, such as a hydroxyl group, an alkyl group (non-limitative examples of which include C₁-C₆ alkyl groups), an alkoxy group (non-limitative examples of which include C₁-C₆ alkoxy groups), unsubstituted amino groups, substituted amino groups (a non-limitative example of which includes an amino group substituted with an alkyl group), aromatic groups, and combinations thereof. Additional “R” groups are described hereinbelow.

The spiropyran molecular system also has an “X” atom, which may be any suitable heteroatom, such as, for example oxygen atoms and/or sulfur atoms.

In STATE 1, the spiropyran molecular system is substantially colorless, is compatible with a nonpolar or nonprotonic solvent, and may be stable in relatively warm conditions (e.g. temperatures greater than about 25° C.). In STATE 2, the merocyanine exhibits a hue (e.g. a purple hue), is compatible with a polar or protonic solvent, and may be stable in relatively cold conditions (e.g. temperatures less than about 25° C.). In STATE 3, the merocyanine H exhibits a hue different than that exhibited in STATE 2 and is compatible with a basic solvent.

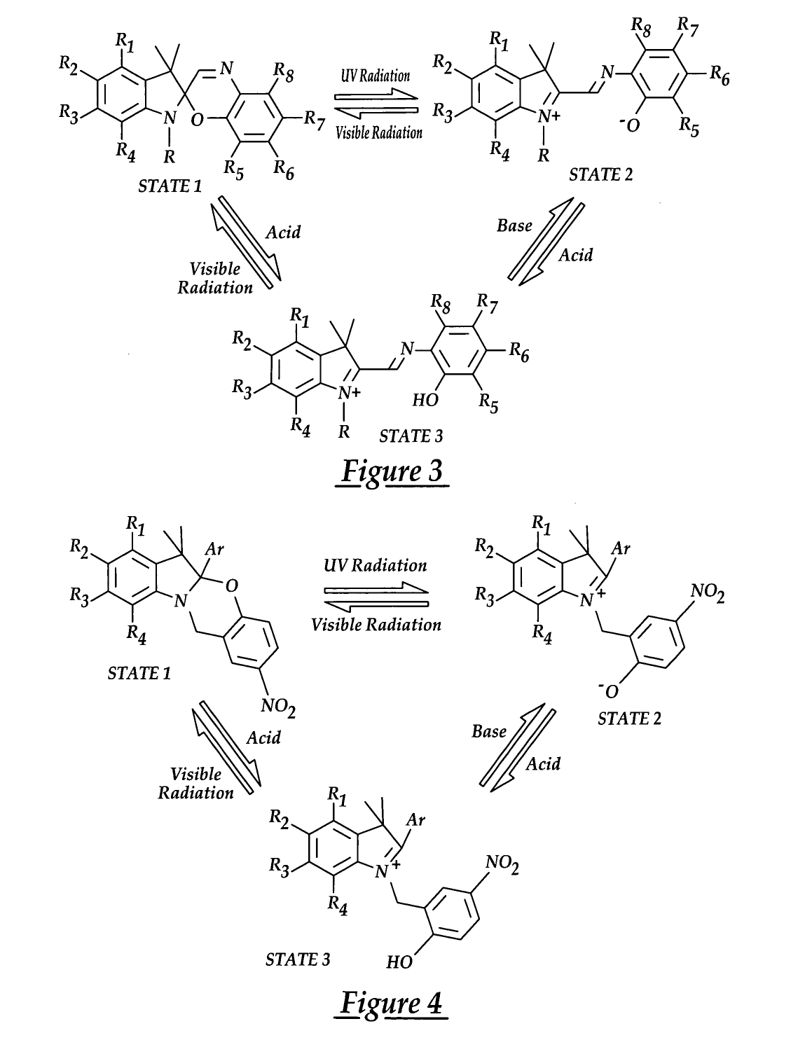

Referring now to FIG. 3, a non-limitative example of a three-stage molecular switch based on spirooxazine derivatives is depicted. When exposed to UV radiation, the compound in STATE 1 undergoes a ring-opening reaction to form the compound in STATE 2. This compound may be protonated by acid to form the compound in STATE 3. The compound in STATE 3 may be reconverted to the compound in STATE 1 when exposed to visible light. As the cycle is reversible, the compound in STATE 1 may be converted into the compound in STATE 3 via acid exposure, the compound in STATE 3 may be converted into the compound in STATE 2 via base exposure, and the compound in STATE 2 may be converted into the compound in STATE 1 via visible light exposure.

It is to be understood that the transformations of the spirooxazine derivatives may take place when the spirooxazine derivatives are mixed with the polymer matrix; or when the derivatives are attached to the polymer matrix.

The spirooxazine derivative molecular system depicted in FIG. 3 has one or more R group(s) (e.g. R₁, R₂, R₃, R₄, R₅, R₆, R₇ and R₈) in each of the three states. In a non-limitative example, the “R” group may be hydrogen groups, halogen groups, alkyl groups, or combinations thereof. The “R” groups may be chloro groups, bromo groups, fluoro groups, methyl groups, ethyl groups, propyl groups, hydroxymethyl groups, hydroxyethyl groups, hydroxylpropyl groups, hydroxybutyl groups, and mixtures thereof. Other non-limitative examples of such group(s) include phenyl groups, diphenylmethyl groups, substituted diphenylmethyl groups (non-limitative examples of which include di(2-methylphenyl)methyl groups, di(2-ethylphenyl)methyl groups, di(2-propylphenyl)methyl groups, di(2-butylphenyl)methyl groups, di(2-tert-butylphenyl)methyl groups, di(3-methylphenyl)methyl groups, di(3-ethylphenyl)methyl groups, di(3-propylphenyl)methyl groups, di(3-butylphenyl)methyl groups, di(3-tert-butylphenyl)methyl groups, di(4-methylphenyl)methyl groups, di(4-ethylphenyl)methyl groups, di(4-propylphenyl)methyl groups, di(4-butylphenyl)methyl groups, di(4-tert-butylphenyl)methyl groups, di(5-methylphenyl)methyl groups, di(5-ethylphenyl)methyl groups, di(5-propylphenyl)methyl groups, di(5-butylphenyl)methyl groups, di(5-tert-butylphenyl)methyl groups, di(6-methylphenyl)methyl groups, di(6-ethylphenyl)methyl groups, di(6-propylphenyl)methyl groups, di(6-butylphenyl)methyl groups, di(6-tert-butylphenyl)methyl groups, and combinations thereof), arylalkyl groups, substituted arylalkyl groups (non-limitative examples of which include halogen substituted arylalkyl groups, and arylalkyl groups substituted with one or more of phenylmethyl groups, (2-methyl)phenylmethyl groups, (2-ethyl)phenylmethyl groups, (2-propyl)phenylmethyl groups, (2-butyl)phenylmethyl groups, (2-tert-butyl)phenylmethyl groups, (3-methyl)phenylmethyl groups, (3-ethyl)phenylmethyl groups, (3-propyl)phenylmethyl groups, (3-butyl)phenylmethyl groups, (3-tert-butyl)phenylmethyl groups, (4-methyl)phenylmethyl groups, (4-ethyl)phenylmethyl groups, (4-propyl)phenylmethyl groups, (4-buthyl)phenylmethyl groups, (4-tert-butyl)phenylmethyl groups, (5-methyl)phenylmethyl groups, (5-ethyl)phenylmethyl groups, (5-propyl)phenylmethyl groups, (5-buthyl)phenylmethyl groups, (5-tert-butyl)phenylmethyl groups, (6-methyl)phenylmethyl groups, (6-ethyl)phenylmethyl groups, (6-propyl)phenylmethyl groups, (6-buthyl)phenylmethyl groups, (6-tert-butyl)phenylmethyl groups, and combinations thereof), diaryl alkyl groups, substituted diaryl alkyl groups (non-limitative examples of which include halogen substituted diaryl alkyl groups, and diaryl alkyl groups substituted with diphenylmethyl groups, such as those previously described), alkyl groups, substituted alkyl groups (non-limitative examples of which include halogen substituted alkyl groups, and alkyl groups substituted with diphenylmethyl groups, such as those previously described), isopropyl groups, tert-butyl groups, tri-alkyl groups, and/or mixtures thereof.

It is to be understood that any of the “R” groups may form a fused ring (e.g. naphthalene or anthracene ring structures) with the parent benzene ring.

FIG. 4 depicts another example of a molecular system capable of switching between three states. This three-stage molecular switch is based on oxazine derivatives. The compound in STATE 1 undergoes a ring-opening reaction to form the compound in STATE 2 when exposed to UV radiation. This compound may be protonated by acid to form the compound in STATE 3. The compound in STATE 3 may be reconverted to the compound in STATE 1 when exposed to visible light. As the cycle is reversible, the compound in STATE 1 may be converted into the compound in STATE 3 via acid exposure, the compound in STATE 3 may be converted into the compound in STATE 2 via base exposure, and the compound in STATE 2 may be converted into the compound in STATE 1 via visible light exposure.

It is to be understood that the transformations of the oxazine derivatives may take place when the oxazine derivatives are mixed with the polymer matrix; or when the derivatives are attached to the polymer matrix. It is to be further understood that the “R” groups (e.g. R₁, R₂, R₃, R₄) may be any of those groups described herein.

Further, the “Ar” group in the oxazine molecular system may be any aromatic ring, such as substituted benzene derivatives, substituted naphthalene derivatives, substituted anthrathene derivatives, or combinations thereof.

Referring now to FIG. 5, a generic embodiment of the method for reversibly switching a molecular system between four states is depicted. The method includes exposing a photochromic compound within the molecular system to radiation, an acid, or a base. Upon such exposure, the photochromic compound switches from one of the four states to an other of the four states.

In the general embodiment shown in FIG. 5, the molecular system is substantially colorless in STATE 1, exhibits a hue in STATE 2, and exhibits a hue different from that exhibited in STATE 2 in STATES 3 and 4. It is to be understood that the hue exhibited in STATES 3 and 4 may be a hue intermediate of STATES 1 and 2. It is to be further understood that the molecule in each of the states exhibits a substantially different hue from those exhibited in each of the other states. Also, it is to be understood that the examples recited herein are not meant to be exhaustive, e.g. STATE 1 may exhibit a hue, STATE 2 may exhibit a substantially different hue than STATE 1, STATE 3 may be substantially colorless, etc.

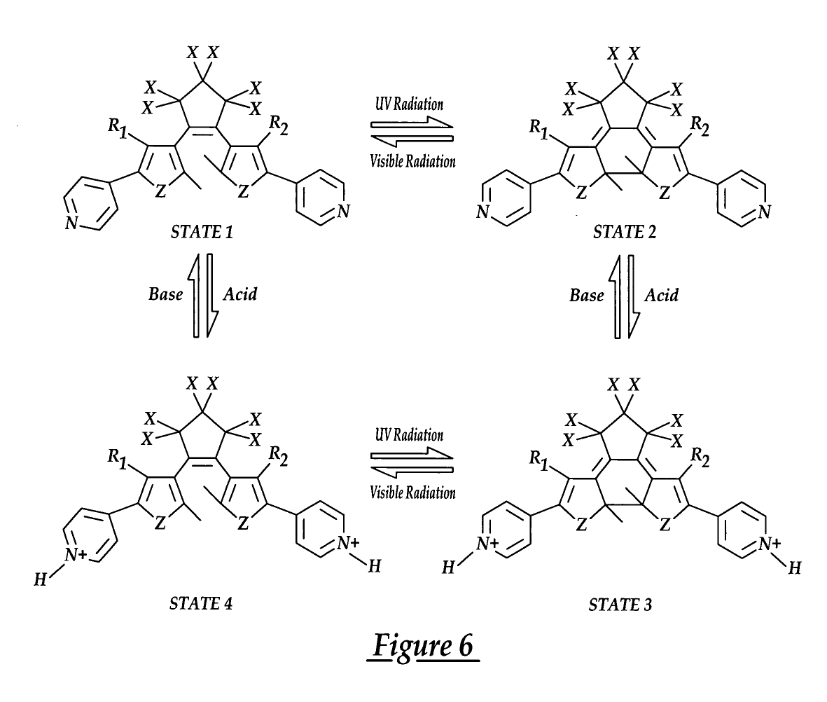

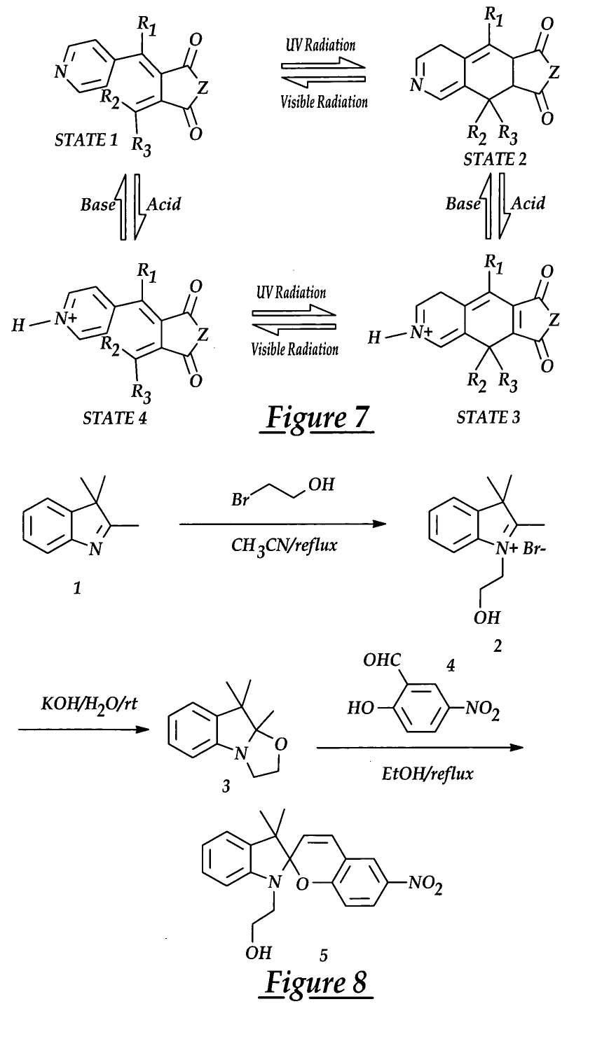

FIGS. 6 and 7 each exhibit non-limitative examples of molecular systems capable of switching between four states. Specifically, FIG. 6 depicts a cyclopentene derivative molecular system and FIG. 7 depicts a fulgide derivative molecular system. It is to be understood that the transformations of the cyclopentene derivatives and the fulgide derivatives may take place when the respective derivatives are mixed with the polymer matrix; or when the respective derivatives are attached to the polymer matrix.

The cyclopentene derivative molecular system in FIG. 6 contains pyridine. It is to be understood, however, that the system may contain some other nitrogen-containing heterocycle. Examples of such nitrogen-containing heterocycle groups or derivatives include, but are not limited to azulene, benzofuran, benzothiophene, benzindazole, benzthiazole, benzimidazole, carbazole, cinnoline, imidazole, indene, isoxazole, isoquinoline, indolizine, indole, isoindole, indoline, indazole, isothiazole, naphthyridine, oxazole, oxadiazole, pyran, pyridazine, pyrazine, pyrazole, pyridine, pyrimidine, purine, phenanthrene, pyrrole, pteridine, phthalazine, pyrrolidine, piperidine, piperazine, quinuclidine, quinazoline, quinoxaline, quinoline, quinolizine, thiazole, triazole, thiadiazole, triazine, and combinations thereof.

The compound in STATE 1 undergoes a cyclic reaction when exposed to UV radiation, thereby forming the compound in STATE 2, which may be protonated by acid to form the compound in STATE 3. Exposing the compound in STATE 3 to visible radiation opens the ring to form the compound in STATE 4, which may be transformed to the compound in STATE 1 with a base.

The cyclopentene derivative molecular system is reversibly switchable. The compound in STATE 1 may be transformed to the compound in STATE 4 via an acid. Exposing the compound in STATE 4 to UV radiation closes the ring and forms the compound in STATE 3, which may be subjected to a base to form the compound in STATE 2. The compound in STATE 2 may be transformed to the compound in STATE 1 upon exposure to visible radiation.

The cyclopentene derivatives include one or more “X” groups that may be hydrogen, fluoro groups, chloro groups, bromo groups, alkyl groups (non-limitative examples of which include methyl groups, ethyl groups, and propyl groups), and combinations thereof. The “Z” groups may be oxygen, sulfur, selenium, tellurium, or combinations thereof. Still further, the “R” groups may be those described herein, such as, for example hydrogen, halogen groups, or alkyl groups.

The fulgide derivative molecular system depicted in FIG. 7 includes a pyridine ring, but may contain any suitable nitrogen-containing heterocycle, such as those previously described. The compound in STATE 1 undergoes a cyclic reaction when exposed to UV radiation, thereby forming the compound in STATE 2, which may be protonated by acid to form the compound in STATE 3. Exposing the compound in STATE 3 to visible radiation forms the compound in STATE 4, which may be transformed to the compound in STATE 1 with a base.

The fulgide derivative molecular system is reversibly switchable. The compound in STATE 1 may be transformed to the compound in STATE 4 via an acid. Exposing the compound in STATE 4 to UV radiation forms the compound in STATE 3, which may be subjected to a base to form the compound in STATE 2. The compound in STATE 2 may be transformed to the compound in STATE 1 upon exposure to visible radiation.

The fulgide derivatives include one or more “Z” groups that may be oxygen, sulfur, selenium, tellurium, or combinations thereof. Still further, the “R” groups (e.g. R₁, R₂, R₃) may be any of those described herein.

Referring now to FIG. 8, a flow diagram depicting the synthesis of spiropyran is depicted. Compound 1 (2,3,3-trimethyl-3H-indole) is reacted with 2-bromoethanol to produce the corresponding salt (Compound 2). Compound 2 may then undergo a cyclic reaction to form Compound 3. Condensation of Compound 3 with 2-hydroxy-5-nitrobenzaldehyde (Compound 4) produces the desired spiropyran (Compound 5).

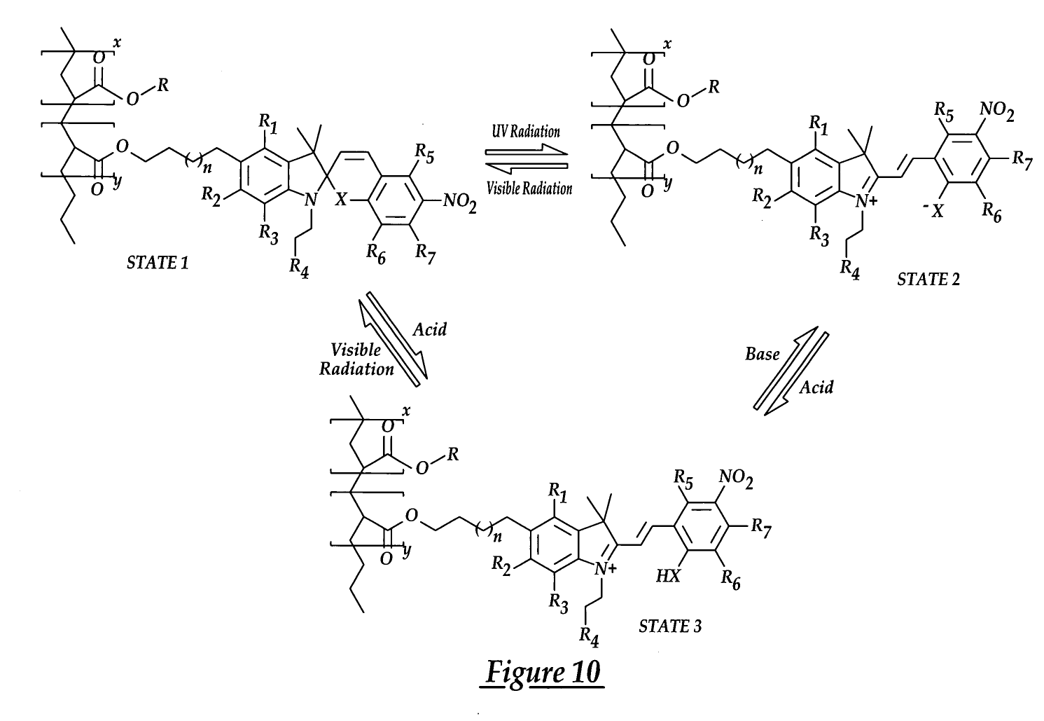

Referring now to FIGS. 9 and 10 together, an embodiment of forming a molecular system 10 and an embodiment of switching that system 10 are respectively depicted. FIG. 9 generally depicts connecting the photochromic compound 12 (a spiropyran derivative) to a monomer 14, and then polymerizing the compound to a relatively soft solid polymer, which can function as a multi-stage molecular switch. More specifically, the reaction of acryloyl chloride 14 with photochromic compound 12 forms a monomer 16 with a photochromic entity group 18, which is relatively stable under polymerization conditions. The polymerization of the monomer 16 with other acrylates 20 in the presence of an initiator results in the molecular system 10 having the photochromic entity group 18 on its surface. The system 10 may function as a multi-stage molecular switch. It is to be understood that the letters “x” and “y” represent the number of monomer units in the polymer backbone, where “x” and “y” are any number greater than or equal to 2. It is to be further understood that the “R” groups (e.g. R, R₁, R₂, R₃, R₄, R₅, R₆, and R₇) may be any of the groups described herein. In this example, “R” may also be an aryl or substituted aryl group.

FIG. 10 illustrates the molecular system 10 of FIG. 9 reversibly switching between three states (similar to the switching described in reference to FIGS. 1-4) upon exposure to one of ultraviolet radiation, visible radiation, an acid, or a base.

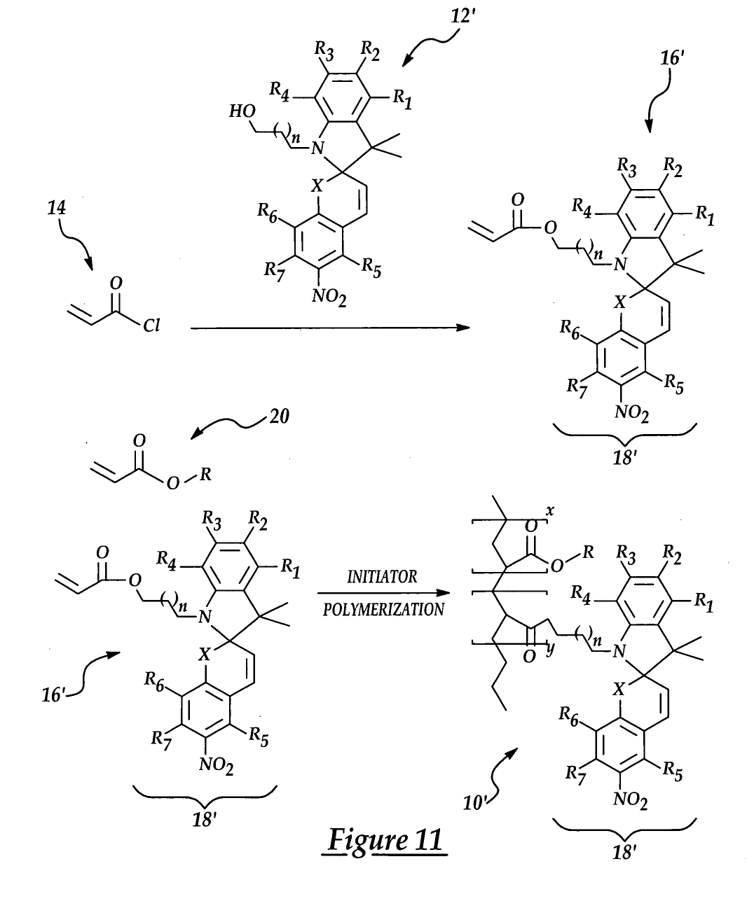

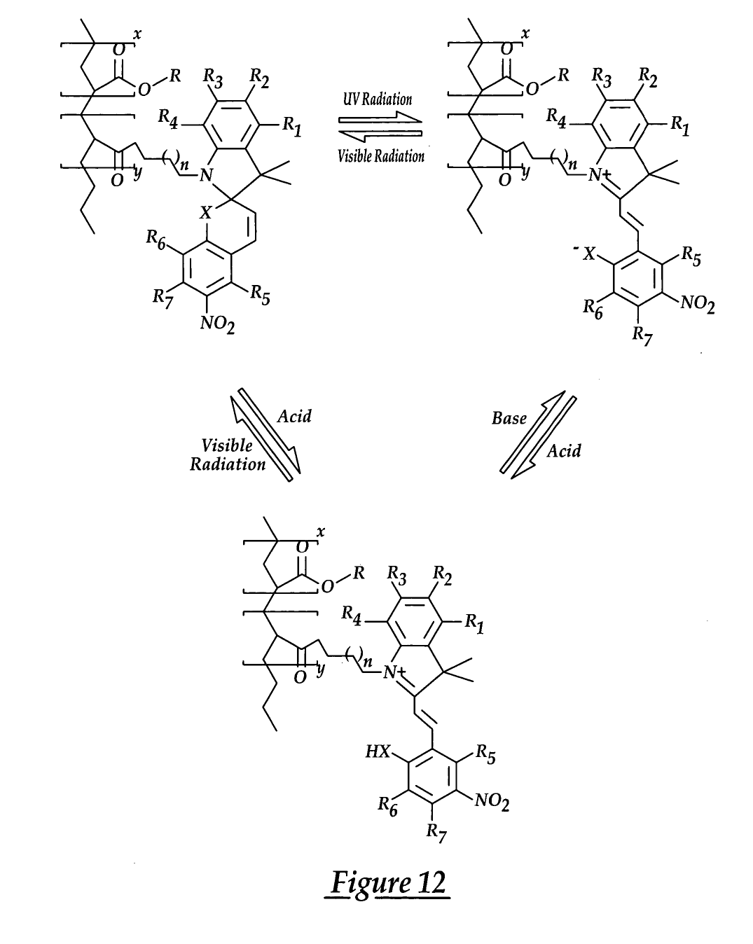

Referring now to FIGS. 11 and 12 together, another embodiment of forming a molecular system and an embodiment of switching that system are respectively depicted. FIG. 11 generally depicts the reaction of acryloyl chloride 14 with photochromic compound 12′ (another spiropyran derivative) formed a monomer 16′ with a photochromic entity group 18′, which is relatively stable under polymerization conditions. The polymerization of the monomer 16′ with other acrylates 20 in the presence of an initiator results in the molecular system 10′ having the photochromic entity group 18′ on its surface. The system 10′ may function as a multi-stage molecular switch. It is to be understood that the letters “x” and “y” represent the number of monomer units in the polymer backbone, where “x” and “y” are any number greater than or equal to 2. It is to be further understood that the “R” groups (e.g. R, R₁, R₂, R₃, R₄, R₅, R₆, and R₇) may be any of the groups described herein. In this example, “R” may also be an aryl or substituted aryl group.

FIG. 12 illustrates the molecular system 10 of FIG. 11 reversibly switching between three states (similar to the switching described in reference to FIGS. 1-4) upon exposure to one of ultraviolet radiation, visible radiation, an acid, or a base.

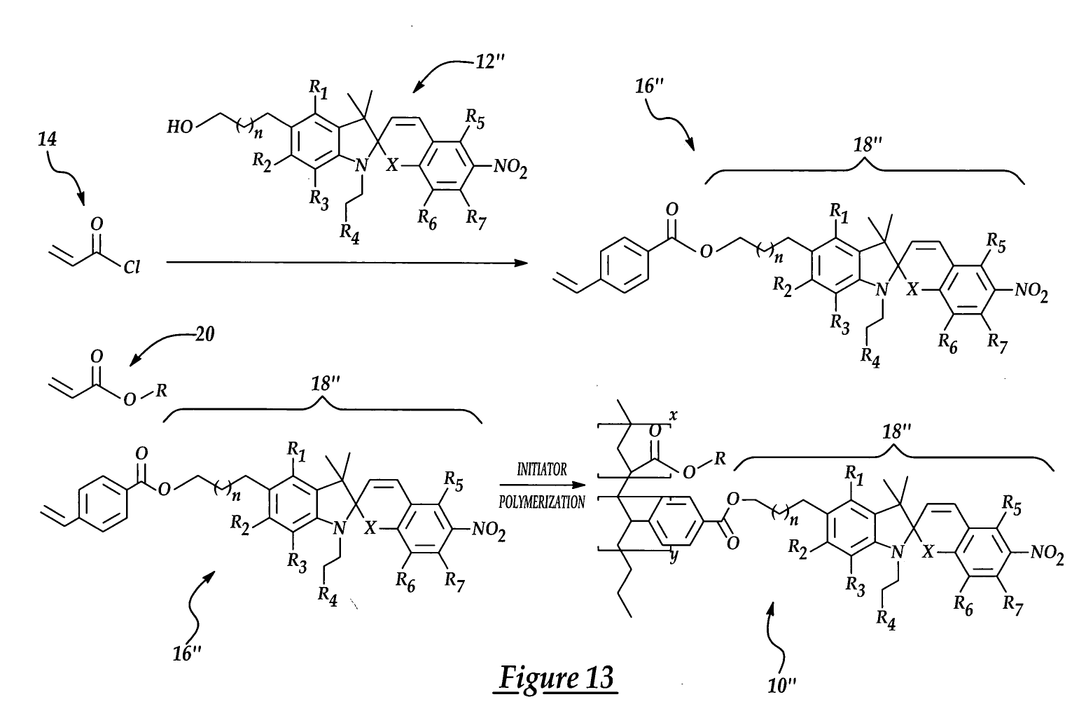

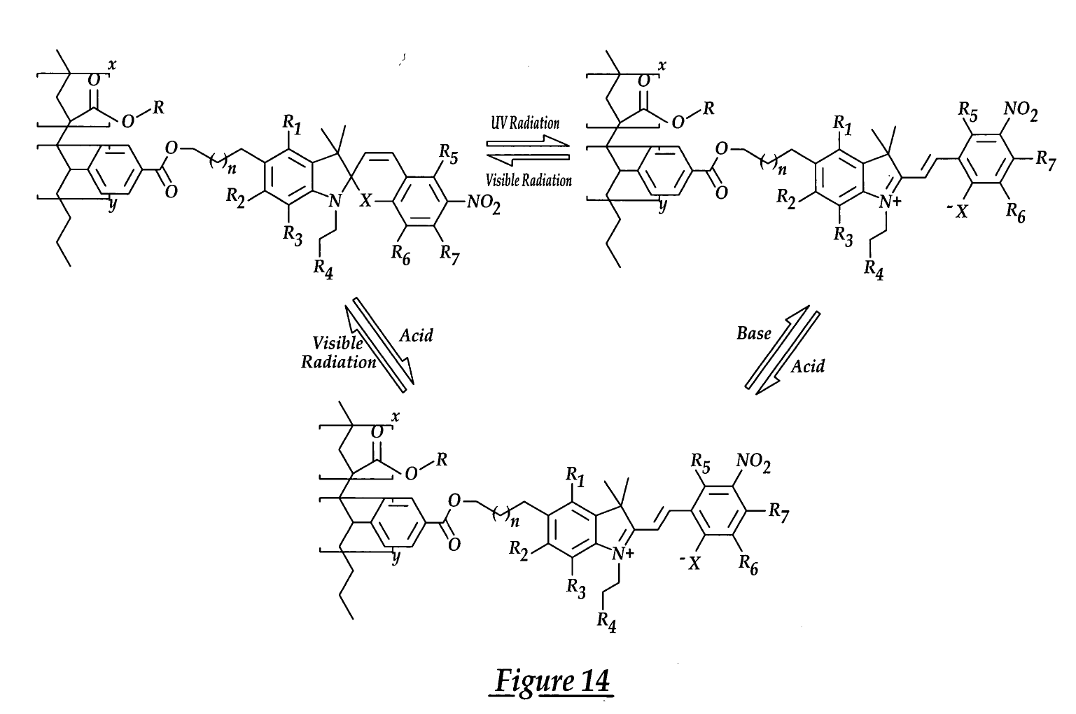

Referring now to FIGS. 13 and 14 together, another embodiment of forming a molecular system and an embodiment of switching that system are respectively depicted. In this non-limitative example, a spiropyran derivative is introduced into a copolymer of acrylate and styrene derivatives.

FIG. 13 generally depicts the reaction of a monomer 14 (4-vinylbenzoic acid chloride) with photochromic compound 12″ formed a monomer 16″ with a photochromic entity group 18″, which is relatively stable under polymerization conditions. The polymerization of the monomer 16″ with other acrylates 20 in the presence of an initiator results in the molecular system 10″ having the photochromic entity group 18″ on its surface. The system 10″ may function as a multi-stage molecular switch. It is to be understood that the letters “x” and “y” represent the number of monomer units in the polymer backbone, where “x” and “y” are any number greater than or equal to 2. It is to be further understood that the “R” groups (e.g. R, R₁, R₂, R₃, R₄, R₅, R₆, and R₇) may be any of the groups described herein. In this example, “R” may also be an aryl or substituted aryl group.

FIG. 14 illustrates the molecular system 10″ of FIG. 13 reversibly switching between three states (similar to the switching described in reference to FIGS. 1-4) upon exposure to one of ultraviolet radiation, visible radiation, an acid, or a base.

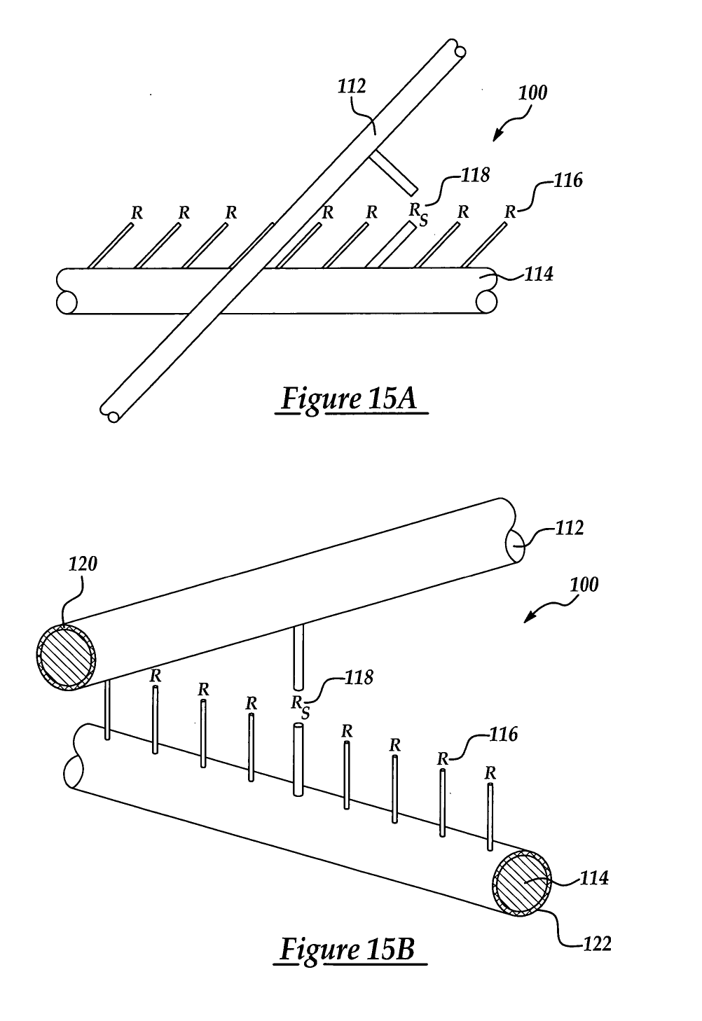

FIGS. 15A and 15B depict an embodiment of a crossed wire switching device 100 that includes two wires 112, 114, each either a metal and/or semiconductor wire, that are crossed at some substantially non-zero angle. Disposed between wires 112, 114 is a layer 116 of molecules and/or molecular compounds, denoted R. The particular molecules 118 that are sandwiched at the intersection (also interchangeably referred to herein as a junction) of the two wires 112, 114 are identified as switch molecules Rₛ. While wires 112, 114 are depicted as having substantially circular cross-sections in FIGS. 15A and 15B, it is to be understood that other cross-sectional geometries are contemplated as being within the purview of the present disclosure, such as, for example, ribbon-like geometries, substantially rectangular geometries, substantially square geometries, non-regular geometries, and the like.

Further, the wires 112, 114 may be modulation-doped by coating their surfaces with appropriate molecules—either electron-withdrawing groups (Lewis acids, such as boron trifluoride (BF₃)) or electron-donating groups (Lewis bases, such as alkylamines) to make them p-type or n-type conductors, respectively. FIG. 15B depicts a coating 120 on wire 112 and a coating 122 on wire 114. The coatings 120, 122 may be modulation-doping coatings, tunneling barriers (e.g., oxides), or other nano-scale functionally suitable materials. Alternatively, the wires 112, 114 themselves may be coated with one or more R species 116; and, where the wires cross, Rₛ 118 is formed. Or yet alternatively, the wires 112, 114 may be coated with molecular species 120, 122, respectively, for example, that enable one or both wires 112, 114 to be suspended to form colloidal suspensions. Details of such coatings are provided in U.S. Pat. No. 6,459,095, entitled “Chemically Synthesized and Assembled Electronic Devices”, issued Oct. 1, 2002, to James R. Heath et al, the disclosure of which is incorporated herein by reference in its entirety.

In an embodiment of a molecular switching device 100, a top electrode 112 crosses a bottom electrode 114 at a non-zero angle, thereby forming a junction. An embodiment(s) of the molecular system described herein may be operatively disposed in the junction. As such, the molecular system may be used as molecule 118 as depicted in FIGS. 15A and 15B.

While several embodiments have been described in detail, it will be apparent to those skilled in the art that the disclosed embodiments may be modified. Therefore, the foregoing description is to be considered exemplary rather than limiting.

What is claimed is:

1. A molecular system, comprising:
a polymer matrix; and
a photochromic compound associated with the polymer matrix;
wherein the photochromic compound is capable of reversibly switching between three or four states upon exposure to at least one radiation and at least one of an acid and a base.

2. The molecular system as defined in claim 1 wherein the polymer matrix comprises polydimethylsiloxane, poly(hexyl acrylate), poly(butyl methacrylate), poly(ethylhexyl methacrylate), poly(benzyl methacrylate), poly(styrene-co-hexyl acrylate), poly(benzyl methacrylate-co-hexyl methacrylate), poly(methyl methacrylate-co-hexyl acrylate), condensation polymers, addition polymers, and mixtures thereof.

3. The molecular system as defined in claim 1 wherein the photochromic compound is capable of reversibly switching between four states and wherein the photochromic compound comprises at least one of cyclopentene derivatives, fulgide derivatives, and mixtures thereof.

4. The molecular system as defined in claim 1 wherein the photochromic compound is capable of reversibly switching between three states, and wherein the photochromic compound comprises at least one of spiropyran, spiropyran derivatives, spirooxazine derivatives, oxazine derivatives, and mixtures thereof.

5. The molecular system as defined in claim 4 wherein spiropyran switches to merocyanine upon exposure to ultraviolet radiation, wherein merocyanine switches to merocyanine H upon exposure to an acid, and wherein merocyanine H switches to spiropyran upon exposure to visible radiation.

6. The molecular system as defined in claim 4 wherein spiropyran switches to merocyanine H upon exposure to an acid, wherein merocyanine H switches to merocyanine upon exposure to a base, and wherein merocyanine switches to spiropyran upon exposure to visible radiation.

7. The molecular system as defined in claim 1 wherein the acid is at least one of hydrochloric acid, hydrobromic acid, nitric acid, sulfuric acid, acetic acid, phosphoric acid, formic acid, propionic acid, benzoic acid, phenols, phenol derivatives, and mixtures thereof.

8. The molecular system as defined in claim 1 wherein the base is at least one of sodium hydroxide, potassium hydroxide, calcium hydroxide, sodium carbonate, potassium carbonate, cesium carbonate, cesium hydroxide, lithium hydroxide, lithium carbonate, and mixtures thereof.

9. The molecular system as defined in claim 1 wherein the photochromic compound is substantially colorless in a first state and exhibits a substantially different hue in at least one of a second state, a third state, and a fourth state.

10. The molecular system as defined in claim 1 wherein the photochromic compound is covalently linked to the polymer matrix or is mixed throughout the polymer matrix.

11. The molecular system as defined in claim 1 wherein the molecular system switches from a first state to a second state upon exposure to ultraviolet radiation, wherein the molecular system switches from the second state to a third state upon exposure to the acid, and wherein the molecular system switches from the third state to the first state upon exposure to visible radiation.

12. The molecular system as defined in claim 1 wherein the molecular system switches from a first state to a second state upon exposure to ultraviolet radiation, wherein the molecular system switches from the second state to a third state upon exposure to the acid, wherein the molecular switches from the third state to a fourth state upon exposure to visible radiation, and wherein the molecular system switches from the fourth state to the first state upon exposure to the base.

13. A method for reversibly switching a molecular system between three or four states, the method comprising exposing a photochromic compound within the molecular system to at least one radiation and at least one of an acid and a base, whereby the photochromic compound switches from one of the three or four states to an other of the three or four states.

14. The method as defined in claim 13 wherein the molecular system further comprises a polymer matrix.

15. The method as defined in claim 14 wherein the photochromic compound is at least one of covalently linked to the polymer matrix and mixed throughout the polymer matrix.

16. The method as defined in claim 13 wherein the photochromic compound is reversibly switchable between four states and wherein the photochromic compound comprises at least one of cyclopentene derivatives, fulgide derivatives, and mixtures thereof.

17. The method as defined in claim 13 wherein the photochromic compound is capable of reversibly switching between three states, and wherein the photochromic compound comprises at least one of spiropyran, spiropyran derivatives, spirooxazine derivatives, oxazine derivatives, and mixtures thereof.

18. The method as defined in claim 17 wherein spiropyran switches to merocyanine upon exposure to ultraviolet radiation, wherein merocyanine switches to merocyanine H upon exposure to an acid, wherein merocyanine H switches to spiropyran upon exposure to visible radiation; and wherein spiropyran switches to merocyanine H upon exposure to an acid, wherein merocyanine H switches to merocyanine upon exposure to a base, and wherein merocyanine switches to spiropyran upon exposure to visible radiation.

19. The method as defined in claim 13 wherein the photochromic compound is substantially colorless in a first state and exhibits a hue in at least one of a second state, a third state, and a fourth state.

20. The method as defined in claim 13, further comprising:
exposing molecular system to ultraviolet radiation, thereby switching the molecular system from a first state to a second state;
exposing the molecular system to an acid, thereby switching the molecular system from the second state to a third state; and
exposing the molecular system to visible radiation, thereby switching the molecular system from the third state to the first state.

21. The method as defined in claim 20, further comprising:
exposing molecular system to an acid, thereby switching the molecular system from the first state to the third state;
exposing the molecular system to a base, thereby switching the molecular system from the third state to the second state; and
exposing the molecular system to visible radiation, thereby switching the molecular system from the second state to the first state.

22. The method as defined in claim 13, further comprising:
exposing the molecular system to ultraviolet radiation, thereby switching the molecular system from a first state to a second state;
exposing the molecular system in the second state to an acid, thereby switching the molecular system from the second state to a third state;
exposing the molecular system in the third state to visible radiation, thereby switching the molecular system from the third state to a fourth state; and
exposing the molecular system in the fourth state to a base, thereby switching the molecular system from the fourth state to the first state.

23. The method as defined in claim 22, further comprising:
exposing the molecular system to an acid, thereby switching the molecular system from the first state to the fourth state;
exposing the molecular system in the fourth state to ultraviolet radiation, thereby switching the molecular system from the fourth state to the third state;
exposing the molecular system in the third state to a base, thereby switching the molecular system from the third state to the second state; and
exposing the molecular system in the second state to visible radiation, thereby switching the molecular system from the second state to the first state.

24. A method for switching a molecular system between three states, the molecular system including a polymer matrix and a photochromic compound associated with the polymer matrix in a first state, the method comprising:
exposing the molecular system to ultraviolet radiation, thereby switching the molecular system from the first state to a second state;
exposing the molecular system in the second state to an acid, thereby switching the molecular system from the second state to a third state; and
exposing the molecular system in the third state to visible radiation, thereby switching the molecular system from the third state to the first state.

25. The method as defined in claim 24 wherein the molecular system is reversibly switchable between the three states.

26. The method as defined in claim 25, further comprising:
exposing the molecular system to acid, thereby switching the molecular system from the first state to the third state;
exposing the molecular system in the third state to a base, thereby switching the molecular system from the third state to the second state; and
exposing the molecular system in the second state to visible radiation, thereby switching the molecular system from the second state to the first state.

27. A method for switching a molecular system between four states, the molecular system including a polymer matrix and a photochromic compound associated with the polymer matrix in a first state, the method comprising:
exposing the molecular system to ultraviolet radiation, thereby switching the molecular system from the first state to a second state;
exposing the molecular system in the second state to an acid, thereby switching the molecular system from the second state to a third state;
exposing the molecular system in the third state to visible radiation, thereby switching the molecular system from the third state to a fourth state; and
exposing the molecular system in the fourth state to a base, thereby switching the molecular system from the fourth state to the first state.

28. The method as defined in claim 27 wherein the photochromic compound is one of cyclopentene derivatives and fulgide derivatives.

29. The method as defined in claim 27 wherein the molecular system is reversibly switchable between the four states.

30. The method as defined in claim 29, further comprising:
exposing the molecular system to an acid, thereby switching the molecular system from the first state to the fourth state;
exposing the molecular system in the fourth state to ultraviolet radiation, thereby switching the molecular system from the fourth state to the third state;
exposing the molecular system in the third state to a base, thereby switching the molecular system from the third state to the second state; and
exposing the molecular system in the second state to visible radiation, thereby switching the molecular system from the second state to the first state.

31. A molecular switching device, comprising:
at least one bottom electrode;
at least one top electrode, the top electrode crossing the bottom electrode at a non-zero angle, thereby forming a junction; and
a molecular system operatively disposed in the junction, the molecular system comprising:
a polymer matrix; and
a photochromic compound associated with the polymer matrix;
wherein the photochromic compound is capable of reversibly switching between three or four states upon exposure to at least one radiation and at least one of an acid and a base.

32. The molecular switching device as defined in claim 31 wherein the polymer matrix comprises polydimethylsiloxane, poly(hexyl acrylate), poly(butyl methacrylate), poly(ethylhexyl methacrylate), poly(benzyl methacrylate), poly(styrene-co-hexyl acrylate), poly(benzyl methacrylate-co-hexyl methacrylate), poly(methyl methacrylate-co-hexyl acrylate), condensation polymers, addition polymers, and mixtures thereof.

33. The molecular switching device as defined in claim 31 wherein the photochromic compound is capable of reversibly switching between four states and wherein the photochromic compound comprises at least one of cyclopentene derivatives, fulgide derivatives, and mixtures thereof.

34. The molecular switching device as defined in claim 31 wherein the photochromic compound is capable of reversibly switching between three states, and wherein the photochromic compound comprises at least one of spiropyran, spiropyran derivatives, spirooxazine derivatives, oxazine derivatives, and mixtures thereof.

35. The molecular switching device as defined in claim 31 wherein the photochromic compound is substantially colorless in a first state and exhibits a hue in a second state, a third state, or a fourth state.

36. The molecular switching device as defined in claim 31 wherein the molecular system switches from a first state to a second state upon exposure to ultraviolet radiation, wherein the molecular system switches from the second state to a third state upon exposure to the acid, and wherein the molecular system switches from the third state to the first state upon exposure to visible radiation.

37. The molecular switching device as defined in claim 31 wherein the molecular system switches from a first state to a second state upon exposure to ultraviolet radiation, wherein the molecular system switches from the second state to a third state upon exposure to the acid, wherein the molecular switches from the third state to a fourth state upon exposure to visible radiation, and wherein the molecular system switches from the fourth state to the first state upon exposure to the base.

38. A method of forming a polymeric molecular system capable of reversibly switching between three or four states, the method comprising:
connecting a photochromic molecule to a monomer; and
polymerizing the monomer to form the polymeric molecular system, wherein the photochromic molecule situates at a surface of the system.
